(19) United States
(12) Patent Application Publication
(10) Pub. No.: US 2017/0362987 A1
(43) Pub. Date: Dec. 21, 2017

(54) ENGINE SYSTEM HAVING MIXING MECHANISM FOR EXHAUST AND INJECTED FLUID AND ENGINE EXHAUST TREATMENT STRATEGY

(71) Applicant: Electro-Motive Diesel, LaGrange, IL (US)

(72) Inventors: Xiao Fu, Chicago, IL (US); Mahesh Munirajappa, Willowbrook, IL (US); Deep Bandyopadhyay, Naperville, IL (US); Haridasa Raghavendra Tantry, Bangalore (IN); Thean Mani Rajan Kanagaraj, Bangalore (IN)

(73) Assignee: Electro-Motive Diesel, LaGrange, IL (US)

(21) Appl. No.: 15/186,666

(22) Filed: Jun. 20, 2016

(51) Int. Cl. F01N 3/28; B01F 5/04; B01F 7/00; F02B 75/02; B01F 3/04; F01N 3/20; B01F 5/06

(52) U.S. Cl. CPC F01N 3/2892; F01N 3/206; B01F 5/0451; B01F 5/0473; B01F 5/0616; F02B 75/02; F01N 3/2066; B01F 3/04049; B01F 7/00275; F01N 2240/20; F01N 2610/02; B01F 2215/0036; F02B 2075/025

(57) ABSTRACT

An engine system includes an internal combustion engine having an exhaust system with an SCR aftertreatment mechanism and a urea injector upstream the aftertreatment mechanism. A mixing mechanism is positioned fluidly between the urea injector and the aftertreatment mechanism and includes a turbulator and a swirler structured to increase mixing of the urea and exhaust gases. Related methodology is also disclosed.

### TECHNICAL FIELD

The present disclosure relates generally to engine aftertreatment, and more particularly to apparatus for increasing mixing of engine exhaust and an injected fluid upstream of an exhaust aftertreatment mechanism.

### BACKGROUND

A great many different exhaust aftertreatment strategies have been developed over the years to reduce certain undesired emissions from internal combustion engines. Such emissions have a number of different forms, notably various oxides of nitrogen collectively referred to as “NOx”, carbon monoxide or “CO”, unburned hydrocarbons, and particulate matter or “PM”. Mechanical trapping mechanisms and various catalyzed chemical treatments are used to reduce certain emissions to desired levels. Engine operating strategies are sometimes used in conjunction with aftertreatment to bring emissions levels down to jurisdictional requirements or objectives.

One aftertreatment strategy that has achieved widespread application is known as selective catalytic reduction or “SCR”. In SCR a reductant is delivered into an exhaust stream and adsorbed onto a catalyst. Nitrogen oxides are converted in the presence of the adsorbed reductant into diatomic nitrogen and water. In some systems a fluid containing urea and generally referred to as diesel emission fluid or “DEF” is injected into the exhaust stream. The urea decomposes into ammonia and water. Ammonia serves as the reductant that reacts with NOx with the assistance of the catalyst. United States Patent Application Publication No. 20110036082 to Collinot is directed to an exhaust element having a static device mounted therein for mixing an injected additive with exhaust gases. The static device includes a helicoid having an axis forming an angle with a direction of flow of the fluid through the exhaust element. While Collinot may achieve his stated objectives, there is always room for improvement.

### SUMMARY

In one aspect, an engine system includes an internal combustion engine including an engine housing defining a plurality of engine cylinders, and an exhaust system coupled with the engine housing and including an exhaust conduit having an exhaust inlet, an exhaust outlet, a fluid injector structured to inject a fluid into the exhaust conduit, and an aftertreatment mechanism coupled with the exhaust conduit. The exhaust system further including a mixing mechanism positioned fluidly between the fluid injector and the aftertreatment mechanism, and having a turbulator positioned within a flow path of exhaust and injected fluid through the exhaust conduit at an upstream location, and a swirler positioned within the flow path at a downstream location.

In another aspect, a mixing mechanism for an engine aftertreatment system includes an exhaust conduit having an upstream end structured to receive a flow of exhaust gas and injected fluid, and a downstream end structured to convey the flow of exhaust gas and injected fluid to an aftertreatment mechanism. The mixing mechanism further includes a turbulator mounted within the exhaust conduit at an upstream location and including flow impingement surfaces structured to induce turbulence in the flow of exhaust gas and injected fluid, and a swirler positioned within the exhaust conduit at a downstream location and including flow impingement surfaces structured to induce swirl in the flow of exhaust gas and injected fluid.

In still another aspect, a method of treating exhaust from an internal combustion engine includes injecting a fluid into exhaust passing through an exhaust conduit, and feeding a flow of the exhaust and injected fluid toward an outlet of the exhaust conduit structured to fluidly connect with an emissions treatment mechanism. The method further includes increasing mixing of the exhaust gas and injected fluid at least in part by impinging the flow upon turbulence-inducing surfaces of a turbulator within the exhaust conduit, and impinging the turbulated flow upon swirl-inducing surfaces of a swirler within the exhaust conduit, prior to discharging the flow from the outlet.

### BRIEF DESCRIPTION OF THE DRAWINGS

FIG. 1 is diagrammatic view of an engine system, according to one embodiment;

FIG. 2 is a diagrammatic view of a swirler for a mixing mechanism in the engine system of FIG. 1, according to one embodiment;

FIG. 3 is an end view of a turbulator for a mixing mechanism in the engine system of FIG. 1, according to one embodiment;

FIG. 4 is an end view of a mixing mechanism, according to one embodiment; and

FIG. 5 is a sectioned side diagrammatic view of a mixing mechanism, according to one embodiment.

### DETAILED DESCRIPTION

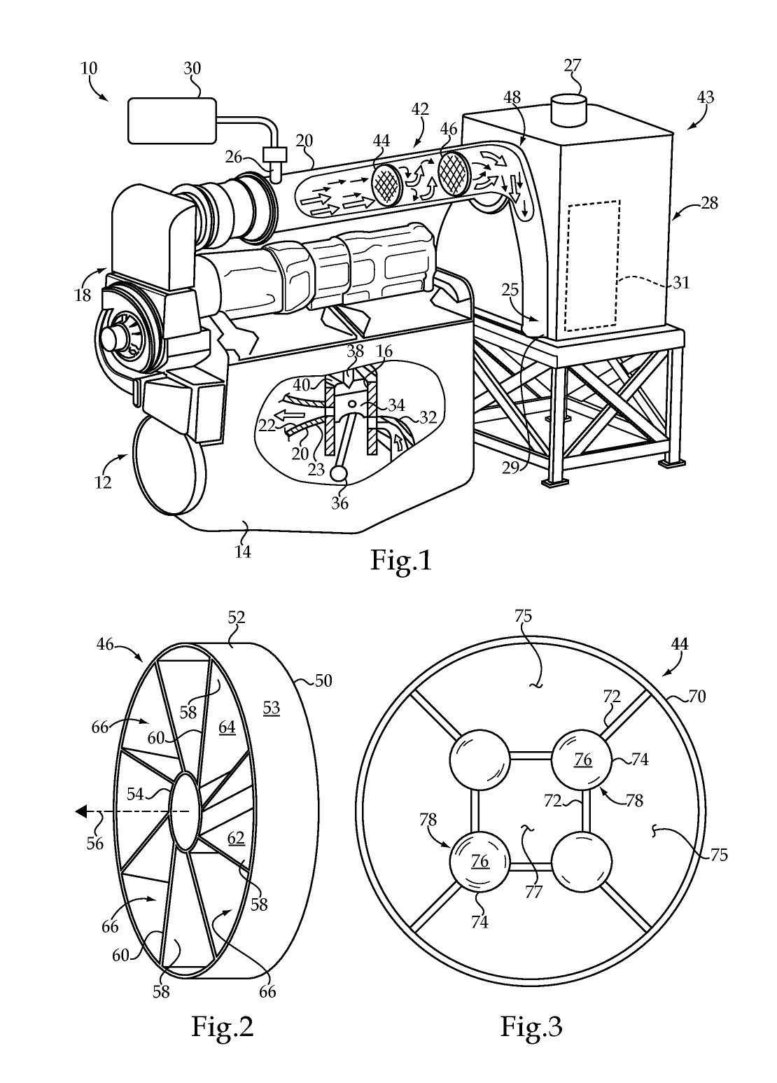

Referring to FIG. 1, there is shown an engine system 10 according to one embodiment, and including an internal combustion engine 12 (or “engine 12”). Engine 12 includes an engine housing 14 defining a plurality of engine cylinders 16. In the FIG. 1 illustration only one cylinder 16 is shown, however, it will be appreciated that a plurality of substantially identical cylinders will be formed within engine housing 14. In a practical implementation strategy engine 12 is a two-stroke engine where a piston 34 reciprocates within cylinder 16 to rotate a crankshaft 36 according to a conventional two-stroke engine cycle. An air intake conduit 32 is coupled with cylinder 16 and provides intake air for combustion. Engine system 10 further includes an exhaust system 18 coupled with engine housing 14 and including an exhaust conduit 20 having an exhaust inlet 22 at an upstream end 23 of exhaust conduit 20 coupled with cylinder 16. Engine 12 may be a direct-injected compression ignition engine. A fuel injector 38 suitable for injecting a fuel such as a diesel fuel is shown positioned partially within cylinder 16 and supported within an engine head 40. It should be appreciated that the illustration of FIG. 1 is diagrammatic only, and features of engine 12, and indeed any part of engine system 10, may vary from the illustrated embodiments. For instance, those skilled in the art will be familiar with two-stroke engine configurations having one or more exhaust valves in an engine head, and engine 12 could be constructed according to such a configuration. In still other instances engine 12 might not be a two-stroke engine at all, and also could be spark-ignited rather than compression ignition.

Engine system 10 further includes an aftertreatment system 43 including an aftertreatment mechanism 28 coupled with exhaust conduit 20. In a practical implementation strategy aftertreatment mechanism 28 includes a selective catalytic reduction (SCR) module, having a catalyst support element 31 with catalyst affixed thereon. Exhaust gases mixed with an injected fluid are conveyed from an exhaust conduit 20 by way of an outlet 25 in a downstream end 29 of exhaust conduit 20 into aftertreatment mechanism 28 such that the gases and injected fluid contact the catalyst. Exhaust gases having been treated to reduce emissions in aftertreatment mechanism 28 are discharged by way of a treated exhaust outlet 27. The injected fluid may include urea or a urea mixture such as DEF. Other fluids containing other suitable reductants, or even a different fluid altogether such as fuel could be used depending upon the exhaust treatment strategy and objectives. Exhaust system 18 further includes a fluid injector 26 coupled with exhaust conduit 20 and structured to inject the fluid for mixing with exhaust. A fluid supply 30, which may include a urea supply, is coupled with injector 26. As will be further apparent from the following description engine system 10 is uniquely configured for increasing mixing of the injected fluid and exhaust gases so as to improve the operation and effectiveness of aftertreatment mechanism 28 without unduly increasing back pressure on engine 12.

To this end, exhaust system 18 further includes a mixing mechanism 42 (or “mechanism 42”) positioned fluidly between fluid injector 20 and aftertreatment mechanism 28, within a segment of exhaust conduit 20. Mechanism 42 includes a turbulator 44 positioned within a flow path of exhaust and injected fluid through exhaust conduit 20 at an upstream location, and a swirler 46 positioned within the flow path at a downstream location. In the FIG. 1 illustration solid arrows generally depict injected fluid, and open arrows generally depict exhaust gases. It can be seen that the flow of exhaust and injected fluid is not well mixed upstream from turbulator 44, that turbulence is induced in the flow after passing through turbulator 44, and that the flow of exhaust and injected fluid is better mixed and swirling after passing through swirler 46. It can also be noted that mixing mechanism 42 is positioned upstream from a bend 48 in exhaust conduit 20. At bend 48 and thereafter exhaust conduit 20 expands vertically and feeds into aftertreatment mechanism 28 by way of an exhaust outlet 25 of exhaust conduit 20. It has been discovered that where mixing of an injected fluid and exhaust is relatively poor prior to a change in flow direction or a change in flow area, a high concentration of injected fluid in a pocket or portion of the flow of fluid can persist as the flow continues downstream and ultimately into aftertreatment mechanism 28. Promoting mixing of injected fluid with the exhaust can reduce concentrations of injected fluid and generally improve the effectiveness of aftertreatment mechanism 28 at reducing certain emissions, notably NOx. The present disclosure enables such improved mixing without unduly increasing back pressure on engine 12 by both inducing or increasing turbulence in the flow of exhaust gases and injected fluid and inducing or increasing swirling. At least some minor turbulence in the flow of exhaust and fluid may exist prior to the flow reaching mixing mechanism 42. The present concept can therefore be understood to induce extra or increased turbulence in many instances. The present techniques differ from certain known strategies which, while successful at mixing exhaust and injected fluid, could do so only at the expense of increased back pressure or undesirable economics of the mixing apparatus itself.

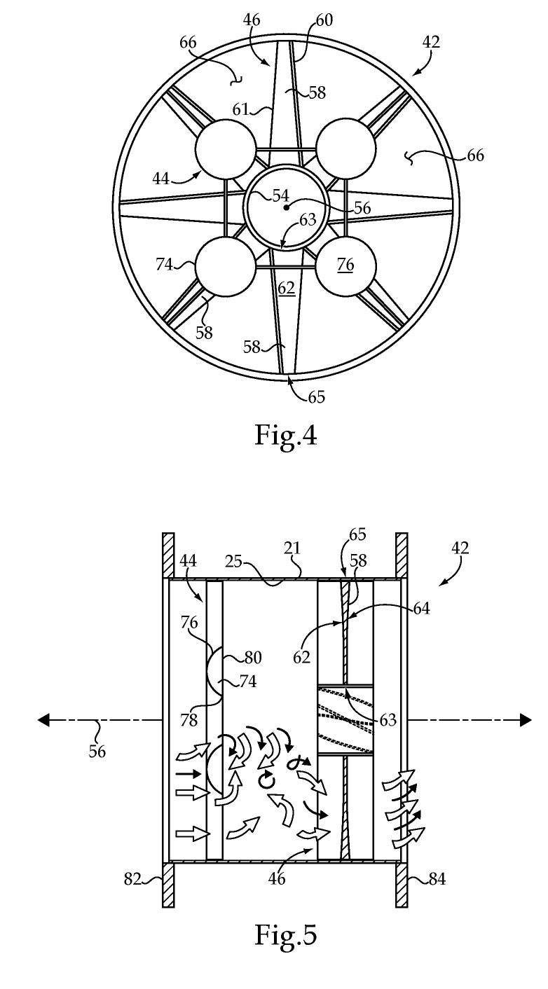

Referring also now to FIG. 2 there is shown swirler 46 illustrating features in greater detail. Swirler 46 includes a frame 50 having an outer frame element 52 with a substantially cylindrical shape, and an inner frame element 54 with a substantially cylindrical shape and being coaxial with outer frame element 52 about a center axis 56. Swirler 46 further includes a plurality of flow impingement surfaces 62 formed upon, for example, a plurality of swirl-inducing elements 58 in the nature of blades 58 (“elements 58” or “blades 58”), and structured for positioning within the flow path of exhaust and injected fluid through exhaust conduit 20 to induce swirl therein. As will be further apparent in view of subsequently described drawings, swirl-inducing elements 58 may be supported within exhaust conduit 20 in a stellate configuration, although the present disclosure is not thereby limited. Each of elements 58 further includes a leading edge 60 and a downstream surface 64 positioned opposite the corresponding upstream flow-impingement surface 62. Trailing edges 61 of elements 58 are shown in FIG. 4, to be described in more detail below. In a practical implementation strategy, elements 58 are eight in number and are uniformly spaced circumferentially about axis 56, and extend radially between frame element 54 and frame element 52. As further discussed herein, elements 58 may be located and contoured in a manner considered optimal for inducing mixing, and structured to cooperate with turbulator 44.

Referring now also to FIG. 3, there is shown a front view of turbulator 44 illustrating a plurality of flow impingement surfaces 76 structured to induce turbulence in the flow of exhaust gas and injected fluid, and located upon turbulence-inducing elements 74 (or “elements 74”). Elements 74 are positioned within a flow of the exhaust and injected fluid, and when turbulator 44 is positioned for service, within exhaust conduit 20 at locations spaced radially inward from an inner wall of exhaust conduit 20. Each of elements 74 may be supported by way of support elements 72 coupled with an outer frame 70. Support elements 72 can have the form of relatively thin metal strips welded or brazed, for example, to elements 74 and to frame 70 and providing only a relatively minor occlusion of a cross-sectional flow area through turbulator 44. Collectively elements 74 and elements 72 may obstruct 25% or less of a cross-sectional flow area through turbulator 44, and potentially about 10% or less of the cross-sectional flow area. Surfaces 76 may be understood as leading surfaces oriented to face the flow of exhaust gas and injected fluid when turbulator 44 is positioned for service in exhaust conduit 20. Elements 78 and surfaces 76 can have rounded shapes, and in some embodiments may have hemispheric shapes. It can also be noted that elements 74 have substantially circular outer perimeters 78, and are arranged in a rhomboid configuration. Elements 74 form with elements 72 and frame 70 a plurality of outer flow channels 75 and a center flow channel 77.

Referring also now to FIG. 4 there is shown mixing mechanism 42 with turbulator 44 and swirler 46 shown as they might appear positioned for service and centered upon axis 56. Trailing edges 61 of elements 58 are shown in FIG. 4. It can also be seen from FIG. 4 that blades 58 are positioned so as to align with elements 74. In particular, it can be seen that blades 58 align with elements 74 and indeed overlap with elements 74 in the axial projection plane of FIG. 4. In a practical implementation strategy, at least some of blades 58 align with elements 74 and blades 58 are positioned such that leading edges 60 intersect elements 74 in the axial projection plane, and are circumferentially offset from elements 72. Also illustrated in FIG. 4 are inboard edges 63 of blades 58 and outboard edges 65. It can be seen from FIG. 4 that inboard edges 63 appear to have a relatively greater circumferential extent than outboard edges 65 in the axial projection plane. In actuality edges 63 and 65 may have similar or identical lengths, but because of a sculpted contour of blades 58 have the appearance of different circumferential extents. Referring also now to FIG. 5, illustrating a sectioned side view of mixing mechanism 42, it can be seen that leading or upstream surfaces 62 and trailing or downstream surfaces 64 have non-linear profiles in a longitudinal section plane. Blades 58 may have a slight twist that results in the sculpted shapes and thus non-linear profiles so as to optimize the swirling induced in the flow of exhaust gas and injected fluid. As used herein, a sculpted surface should be understood as a surface having a shape that varies simultaneously in multiple dimensions. Thus, a surface having a curvature that is uniform along a length or width dimension of the surface would probably not be considered sculpted. A surface having a curvature that varies along a length or width dimension would likely be considered sculpted. Blades 58 or analogous swirl-inducing elements could be substantially planar in other embodiments, or have still other curved, non-curved, or twisted shapes. It can further be seen from FIG. 5 that elements 74 have trailing surfaces or back surfaces that face a downstream direction and are substantially planar. Surfaces 76 face upstream and have rounded shapes as described, and in the illustrated embodiment surfaces 76 and elements 74 generally can be understood to have hemispheric shapes.

### INDUSTRIAL APPLICABILITY

Referring to the drawings generally, but in particular to FIG. 5 there are shown solid arrows representing injected fluid, and open arrows representing exhaust gas flow through a segment 21 of exhaust conduit 20 having turbulator 44 and swirler 46 coupled therewith. For clarity fluid flow is depicted only through the part of mechanism 42 toward the bottom of the page in FIG. 5. End flanges 82 and 84 are provided for mounting segment 21 to adjoining parts of exhaust system 20. Reference numeral 21 indicates an inner wall of exhaust conduit 20. As the flow of exhaust gas and injected fluid approaches turbulator 44 the constituents may experience some mixing but can also be expected to remain somewhat segregated, as a plume of injected fluid from injector 26 will mix with exhaust gases only relatively slowly as the flow of exhaust gases and injected fluid is fed through exhaust conduit 20 and toward outlet 25 to discharge into aftertreatment mechanism 28. As the flow of exhaust and injected fluid reaches turbulator 44 some of the exhaust and injected fluid will impinge upon surfaces 76. Due to the shape of surfaces 76, exhaust and injected fluid will tend to flow around elements 74 relatively smoothly but typically begin to form eddies or other properties of turbulent flow, as illustrated near outer peripheral edge 78, approximately upon or just after reaching edge 78.

The turbulent flow properties can be expected to persist at least to some degree as the exhaust gas and injected fluid advance toward swirler 46 and begin to impinge upon blades 58. The swirling flow that is induced in the exhaust gas and injected fluid can further increase mixing beyond the increase in mixing that results from the inducing of turbulence, and can be expected to persist temporarily after the exhaust gas and injected fluid exits swirler 46. The swirling motion can, moreover, assist in distributing the exhaust and injected fluid mixture into the changing shape of exhaust conduit 20 as it approaches aftertreatment mechanism 28. After exiting swirler 46, and prior to discharging the flow from outlet 25 to feed into aftertreatment mechanism 28, the exhaust gas and injected fluid mixture can change direction of flow at bend 48, and thenceforth pass by way of outlet 25 into aftertreatment mechanism 28. As discussed above certain features of mixing mechanism 42 are optimized to increase mixing sufficiently to improve performance of aftertreatment mechanism 28 while not substantially increasing back pressure on engine 12. Those skilled in the art will appreciate the sensitivity to back pressure of certain engines, notably two-stroke engines that can have difficulty in successfully expelling exhaust and drawing in fresh intake air for combustion if there is too much back pressure. In coupling the turbulence inducing properties of turbulator 44 with the swirl inducing effect of swirler 46 the present disclosure enables robust mixing without unduly restricting fluid flow as is the case in certain other known designs.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon examination of the attached drawings and appended claims.

What is claimed is:

1. An engine system comprising:
an internal combustion engine including an engine housing defining a plurality of engine cylinders; and
an exhaust system coupled with the engine housing and including an exhaust conduit having an exhaust inlet, an exhaust outlet, a fluid injector structured to inject a fluid into the exhaust conduit, and an aftertreatment mechanism coupled with the exhaust conduit;
the exhaust system further including a mixing mechanism positioned fluidly between the fluid injector and the aftertreatment mechanism, and having a turbulator positioned within a flow path of exhaust and injected fluid through the exhaust conduit at an upstream location, and a swirler positioned within the flow path at a downstream location.

2. The system of claim 1 further comprising a supply of urea coupled with the fluid injector, and wherein the aftertreatment mechanism includes a selective catalytic reduction (SCR) module.

3. The system of claim 2 wherein the exhaust conduit forms a bend upstream the aftertreatment mechanism, and the mixing mechanism being positioned upstream from the bend.

4. The system of claim 3 wherein the engine includes a two-stroke engine.

5. The system of claim 1 wherein the turbulator includes a plurality of turbulence-inducing elements positioned within the flow path.

6. The system of claim 5 wherein the turbulence-inducing elements include leading surfaces facing an upstream direction and each having a rounded shape.

7. The system of claim 6 wherein the leading surfaces each have a hemispheric shape.

8. The system of claim 5 wherein the swirler includes a plurality of swirl-inducing blades positioned within the flow path.

9. The system of claim 8 wherein the turbulator and the swirler are centered upon a center axis of the exhaust conduit, and at least some of the plurality of swirl-inducing blades are positioned so as to align with the turbulence-inducing elements in an axial projection plane.

10. A mixing mechanism for an exhaust aftertreatment system comprising:
an exhaust conduit including an upstream end structured to receive a flow of exhaust gas and an injected fluid, and a downstream end structured to convey the flow of exhaust gas and injected fluid to an aftertreatment mechanism;
a turbulator mounted within the exhaust conduit at an upstream location and including flow impingement surfaces structured to induce turbulence in the flow of exhaust gas and injected fluid; and
a swirler positioned within the exhaust conduit at a downstream location and including flow impingement surfaces structured to induce swirl in the flow of exhaust gas and injected fluid.

11. The mechanism of claim 10 wherein the turbulator flow impingement surfaces are located upon turbulence-inducing elements supported within the exhaust conduit at locations spaced radially inward from an inner wall of the exhaust conduit and radially outward from a center axis of the exhaust conduit.

12. The mechanism of claim 11 wherein the swirler flow impingement surfaces are located upon swirl-inducing elements supported within the exhaust conduit in a stellate configuration.

13. The mechanism of claim 11 wherein the swirl-inducing elements are positioned so as to overlap the turbulence-inducing elements in an axial projection plane.

14. The mechanism of claim 11 wherein the swirler flow impingement surfaces include upstream surfaces of swirl-inducing blades each having sculpted contour.

15. The mechanism of claim 11 wherein the turbulator flow impingement surfaces include leading surfaces each having a rounded shape.

16. The mechanism of claim 15 wherein the turbulator flow impingement surfaces each has a hemispheric shape.

17. A method of treating exhaust from an internal combustion engine comprising:
injecting a fluid into exhaust passing through an exhaust conduit;
feeding a flow of the exhaust and injected fluid toward an outlet of the exhaust conduit structured to fluidly connect with an aftertreatment mechanism; and
increasing mixing of the exhaust gas and injected fluid at least in part by impinging the flow upon turbulence-inducing surfaces of a turbulator within the exhaust conduit, and impinging the turbulated flow upon swirl-inducing surfaces of a swirler within the exhaust conduit, prior to discharging the flow from the outlet.

18. The method of claim 17 wherein increasing mixing further includes impinging the flow upon hemispheric turbulence-inducing elements of the turbulator.

19. The method of claim 17 further comprising changing a direction of the flow after the increasing of the mixing.

20. The method of claim 19 wherein the injecting includes injecting a fluid containing urea, and further comprising feeding the mixed exhaust gas and injected fluid from the outlet into a selective catalytic reduction (SCR) module.
